(19) United States
(12) Patent Application Publication
(10) Pub. No.: US 2023/0396627 A1
(43) Pub. Date: Dec. 7, 2023

(54) Method for controlling access to services, associated methods and associated devices

(71) Applicant: Orange, Issy-Les-Moulineaux (FR)

(72) Inventors: Patrick Kirschbaum, Chatillon Cedex (FR); Sylvie Gaspar, Chatillon Cedex (FR)

(21) Appl. No.: 18/247,338

(22) PCT Filed: Sep. 24, 2021
(86) PCT No.: PCT/FR2021/051654

§ 371 Date: Mar. 30, 2023

(30) Foreign Application Priority Data
Sep. 30, 2020 (FR) 2009999

(51) Int. Cl. H04L 9/40; G06F 21/62; G06F 21/32

(52) U.S. Cl. CPC H04L 63/102; G06F 21/629; H04L 63/0861; G06F 21/32

(57) ABSTRACT

A method for controlling access to televised or audio services provided by a service provider server. The method is implemented by the service provider server and includes: receiving a service request comprising an identifier of a customer account and an identifier of a first communication terminal; transmitting a text message confirmation to the first communication terminal; receiving an authentication code from the first communication terminal; and accessing at least one televised service if the authentication code received is identical to an authentication code stored in a database and linked to the identifier of the customer account.

### CROSS-REFERENCE TO RELATED APPLICATIONS

This application is a Section 371 National Stage Application of International Application No. PCT/FR2021/051654, filed Sep. 24, 2021, the content of which is incorporated herein by reference in its entirety, and published as WO 2022/069823 on Apr. 7, 2022, not in English.

### TECHNICAL FIELD OF THE INVENTION

The invention relates to the personalization and control of access to remote services.

### STATE OF THE PRIOR ART

Televised services such as series can be personalized so that each member of the family knows which episodes of the series they have watched. Some services allow personalization of favorite channels. This personalization is implemented through profile creation. These profiles are sometimes protected by a code to be entered or by facial recognition as in US patent 2013 0329966. However, these solutions do not allow verifying a right to access a customer account by a third-party communication terminal.

### SUMMARY OF THE INVENTION

An exemplary aspect of the present application relates to a method for controlling access to services, the services being provided by a service providing device and intended for a playback system, characterized in that the method comprises the following steps implemented by the service providing device:
transmitting a confirmation request to a first communication terminal associated with a customer account in the service providing device, after receiving an access request for at least one service, the access request coming from the playback system and comprising an identifier of said customer account,
then, accessing said at least one service if an authentication code received from said first communication terminal is identical to an authentication code associated with the customer account.

Advantageously, this control method allows a high level of control by the account holder over the use of his or her account at an access provider.

Advantageously, numerous services can be controlled such as accessible channels, favorite channels, and by extension all the services available from a service provider such as the control of connected objects, home automation services, or even alarms. Advantageously, this control can be carried out remotely with a high level of security and does not require the account holder to be physically present in front of the television.

The features set forth in the following paragraphs may optionally be implemented. They may be implemented independently of each other or in combination with each other: According to one embodiment, the received access request for said at least one service was sent by one of the following devices:
the first communication terminal,
a playback system comprising a communication unit for communicating with the communications network and a display screen.

According to one embodiment, the customer account comprises at least one service identification linked to the identifier of the first communication terminal and to the identifier of the customer account, said access being given to the identified communication terminal only for the service or services having a service identification mentioned in the customer account and linked to the identifier of the first communication terminal.

According to one embodiment, the customer account comprises an identifier of a second communication terminal having subscribed to the customer account and an authentication code of said second communication terminal, and the customer account comprises an authorization upon request, the method further comprising the following steps:
transmitting an authorization request to the second communication terminal,
receiving a response and an authentication code from the second communication terminal, said response being an access authorization or refusal for the service,
implementing the response if the authentication code received is identical to the authentication code of the second communication terminal stored in the customer account.

According to one embodiment, the services are provided by a service providing device, said service providing device being connected to a communications network, said service providing device hosting a database storing at least one customer account, the customer account being identified by an identifier, the customer account comprising identification data linked to the identifier of the customer account, the identification data including an identifier of at least one first communication terminal and at least one authentication code for said at least one first communication terminal; said first communication terminal having a right to use the customer account; said first communication terminal comprising at least one communication unit for communicating with the communications network, an access control application, and an authentication application capable of generating the authentication code.

The invention also relates to a service providing device providing services intended for a playback system, the service providing device comprising:
a transmitter which sends a confirmation request to a first communication terminal associated with a customer account in the service providing device, after receiving an access request for at least one service, the access request coming from the playback system and comprising an identifier of said customer account,
an access provider for said at least one service if an authentication code received from said first communication terminal is identical to an authentication code associated with the customer account.

Advantageously, this method makes it possible to increase knowledge about the customer by the service provider. It also allows a more fine-tuned management of customer preferences.

The invention also relates to a method for the confirmation, with a service providing device, of an access request for at least one service, characterized in that the method comprises the following steps implemented by the first communication terminal:
receiving a confirmation request coming from the service providing device,
transmitting an authentication code to the service providing device, said authentication code being generated by an authentication application after authentication of biometric data of the owner of the first communication terminal or after authentication of a personal identification number entered on the first communication terminal.

Advantageously, this method is easy and quick to use for the first communication terminal.

According to one embodiment, said authentication code of the first communication terminal is generated only after authentication of biometric data of the owner of the first communication terminal.

The invention also relates to a communication terminal characterized in that it further comprises an access control application suitable for receiving a confirmation request and for transmitting an authentication code generated by an authentication application after authentication of biometric data of the owner of the first communication terminal or after authentication of a personal identification number entered on the first communication terminal.

The invention also relates to a method for the enrichment of a memory of a service providing device for controlling access to services, said service providing device being connected to a communications network, said service providing device comprising a generator suitable for generating an installation code, characterized in that the method comprises the following steps implemented by the service providing device:
generating an installation code and saving said installation code while associating it with the identifier of the customer account,
transmitting said installation code to the first communication terminal,
receiving a message from the first communication terminal, said message including the authentication code of the first communication terminal, the identifier of the first communication terminal, and said installation code,
saving the received authentication code in a memory of the device such that said authentication code is associated with the identifier of the customer account and with the identifier of the first communication terminal by using the installation code.

Advantageously, the customer account can be easily and quickly enriched by registering a new first terminal.

Advantageously, it is also fast and easy to delete a first communication terminal existing in the database.

According to one embodiment, the method further comprises the following steps:
receiving the identifier of the customer account, the identifier of the first communication terminal, and at least one service identification, only the service having said identification being authorized for viewing by said first communication terminal,
saving said at least one service identification in a memory of the service providing device, said at least one service identification being linked to the identifier of the first communication terminal and to the identifier of the customer account.

According to one embodiment, the method further comprises a step of transmitting a text message to the first communication terminal to confirm the saving of said at least one service identification in the memory of the service providing device.

The invention also relates to a method for the installation, on a first communication terminal, of access control for services, characterized in that the method comprises the following steps implemented by the first communication terminal connected to the communications network:
receiving an installation code coming from the service providing device,
downloading an access control application to the first communication terminal,
generating an authentication code, by the authentication application, after authentication of biometric data of the owner of the first communication terminal or after authentication of a personal identification number entered on the first communication terminal,
transmitting the installation code, the generated authentication code, and the identifier of the first communication terminal, to the service providing device.

Advantageously, the access control application can be easily installed.

Advantageously, it is possible to install several access control applications, each access control application being specific to a service providing device providing different services.

According to one embodiment, said authentication code of the first communication terminal is generated only after authentication of biometric data of the owner of the first communication terminal.

### BRIEF DESCRIPTION OF FIGURES

FIG. 1 is a schematic view of an example system for controlling access to services, the system comprising a service providing device and a user communication terminal according to the invention,

FIG. 2 is a table representing an example of data stored in two customer accounts of a database of the service providing device according to the invention;

FIG. 3 is a timing diagram representing the main steps of a method for the enrichment of a database and a method for the installation of access control on a first communication terminal;

FIG. 4 is a timing diagram representing the main steps of the method for controlling access according to the invention implemented by the service providing device and representing the main steps of the method for the confirmation of an access request for a service by a first communication terminal; and

FIG. 5 is a timing diagram representing the main steps for implementing the authorization upon request function.

### DETAILED DESCRIPTION OF THE INVENTION

In the present patent application, a communication terminal belonging to a user who has subscribed to the services offered by a service providing device is called a “second communication terminal”. Another communication terminal belonging to a different user than the subscribed user is called a “first communication terminal”. The first communication terminal benefits from access to the services by means of usage authorization granted by the user of the second communication terminal.

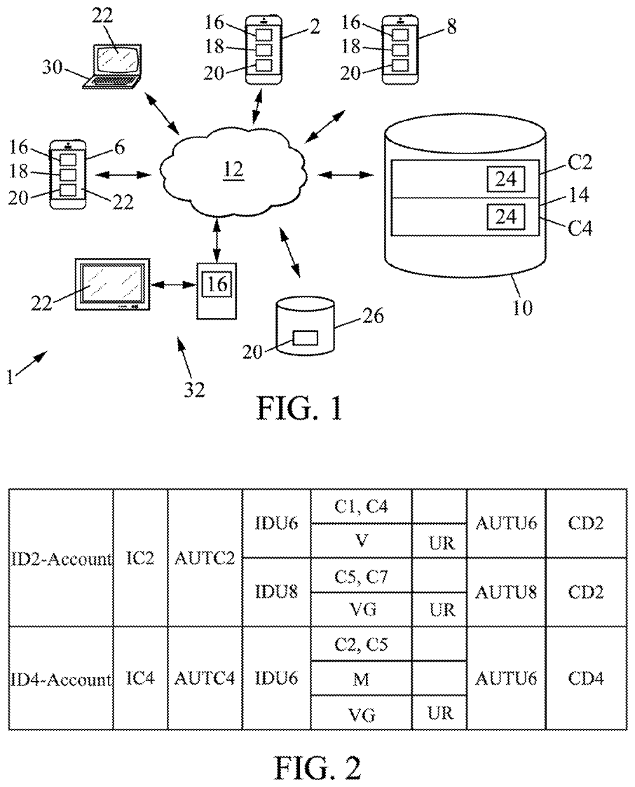

The methods according to the invention are implemented in an access control system 1 such as the system represented in FIG. 1. With reference to FIG. 1, the access control system 1 comprises a communications network 12, a second communication terminal 2 connected to network 12, a first communication terminal 6 connected to network 12, and possibly one or more playback systems 28 also connected to network 12.

Communications network 12 is for example an Internet. In such context, exchanges are in accordance with the Internet protocol.

Communication terminals 2, 6 are, for example, smartphone type mobile telephones. They comprise a communication unit 16 for communicating with network 12, a display screen 22, and a SIM, USIM, or microSIM card. They can be connected to communications network 12 via a wireless access network, such as a GSM, UMTS, 3G, 4G, 5G, etc., mobile network.

Communication terminals 2, 6 comprise in memory an authentication application 18 suitable for implementing the steps of an authentication method based on recognition of a personal identification number (also called a PIN code) or based on recognition of a biometric element such as a fingerprint. In the latter case, communication terminals 2, 6 are equipped with a fingerprint sensor, a retinal analysis module, and/or a facial recognition module. When the PIN code or the biometric data is recognized, the authentication application is configured to verify that this biometric data is indeed identical to that of the holder of record of the communication terminal. When this biometric data is identical to that of the holder of record of the communication terminal, the authentication application generates an authentication code AUTC2, AUTU6. This authentication code is specific to each communication terminal. In the context of the invention, acceptance of the biometric data is used to authenticate the communication terminal. The biometric data itself is not used and is not stored in the memory of the communication terminal.

Finally, communication terminals 2, 6 comprise in memory an access control application 20 configured to control authentication application 18 and to transmit and receive messages or notifications via communication unit 16. Access control application 20 is suitable for implementing the steps of a method for the installation of access control on a first communication terminal, thus the steps of a method for the confirmation of an access request. These methods are described below.

Each playback system 28 comprises a communication unit 16 for communicating with the communications network, and a display screen 22. Playback system 28 can for example be composed of either a playback terminal such as a personal computer 30, a tablet, or a television directly connected to the communications network, or of an assembly 32 comprising a television 32 connected by wired or wireless link to the set top box. The playback system can be used by different users. The playback terminal is separate from the first communication terminal 6.

Access control system 1 further comprises a service providing device 10 connected to network 12. The service providing device is a web server which hosts paid online services. These services include the supply of multimedia content such as, for example, pay television, video games, films, music, videos (replay, VOD), home automation services. The services are web services. They may be obtained by means of a browser executed on the communication terminals or on a playback system. The service providing device comprises web pages which allow receiving requests and transmitting information to mobile telephone types of communication terminals or to playback systems 28 so as to provide the service in question.

Finally, service providing device 10 comprises or is linked to a memory storing a database 14. In the embodiment represented in FIG. 1, the database is stored in the service provider server. The embodiment shown in FIG. 1 is in no way limiting.

Database 14 stores customer accounts C2, C4. FIG. 2 shows an example of two customer accounts C2, C4. Customer account C2, subscribed to by second communication terminal 2, is identified by an identifier denoted “ID2-Account”. Customer account C4, subscribed to by second communication terminal 6, is identified by a different identifier denoted “ID4-Account”. Each customer account comprises identification data linked to the customer account identifier. For example, the identification data contained in customer account C2 include:
an identifier IDC2 of second communication terminal 2,
an authentication code AUTC2 of the second communication terminal,
an installation code CD2,

and for each first communication terminal having a right to use customer account C2:
an identifier of the first communication terminal—for example identifiers IDU6, IDU8 of first communication terminals 6, 8,
an authentication code of the first communication terminal—for example authentication codes AUTU6, AUTU8 of first communication terminals 6, 8,
identifications C1, C4, V of services authorized for the first communication terminal—for example service identifications C1, C4, V for first communication terminal 6 and authorized service identifications C5, C7, VG for first communication terminal 8, and possibly an authorization upon request UR.

The set of identification data is linked to the identifier of the customer account, for example to the identifier “ID2-Account” in the example described above.

The right of use is the possibility offered to a customer who is a customer account holder, to share with users of communication terminals the services acquired through the subscription to his or her customer account. A list of the identifiers of the first communication terminals having this right of use is transmitted by the holder of the customer account to the service provider server. Patent application FR 2008839 in the name of the Applicant describes an exemplary implementation of such a right of use.

The identifier of second communication terminal 2 is, for example, the telephone number of second communication terminal 2. The identifier of first communication terminal 6 is, for example, the telephone number of first communication terminal 6. Alternatively, the identifier of the second communication terminal and the identifier of the first communication terminal can be their international mobile subscriber identity (IMSI) number.

Authentication codes AUTC2, AUTU6 are generated by authentication applications 18 after authentication of biometric data of the owner of the second communication terminal or of the first communication terminal. The authentication codes can also be generated after authentication of a personal identification number entered on the second communication terminal or on the first communication terminal.

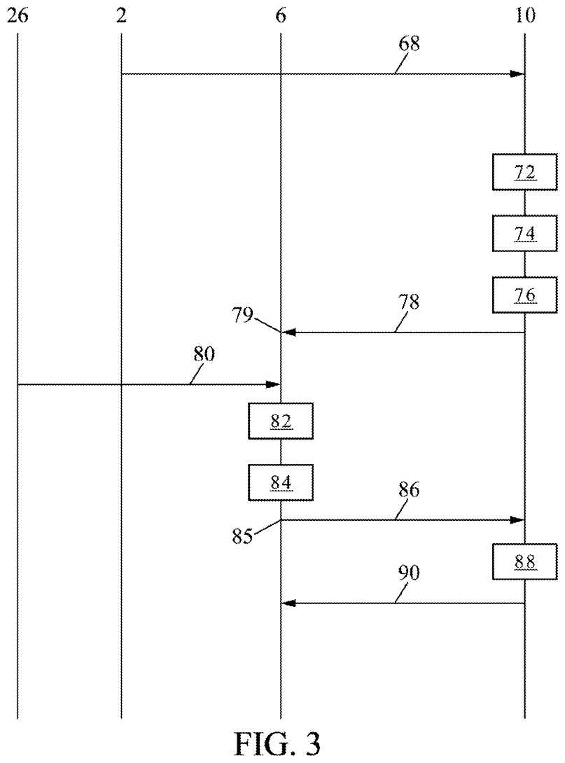

Installation code CD2 is a temporary code generated by a code generator 24. It is specific to each customer account. It is only used when installing access control on a first communication terminal and when enriching database 14 by adding one or more new first communication terminals as explained below in conjunction with the method illustrated in FIG. 3.

Service identifications C1, C4, V are composed of codes enabling the services to be identified. For example, codes C1, C4 represent television channels 1 and 4. Codes V and VG respectively represent a video service and a video game service. Code M represents a music service.

Authorization upon request UR is a function enabling the customer account holder to give occasional and non-permanent authorizations for use. According to this service, the account holder receives a service access authorization request message each time a first communication terminal 6 or a playback system 28 sends a service request to the service provider server. The customer account holder can then authorize or refuse the service. This refusal or acceptance is only valid for this access authorization request. First communication terminal 6 or playback system 28 will have to resubmit the access authorization request when it once again wishes to have access to this service. And the second communication terminal can accept or refuse this new request regardless of the choice (acceptance or refusal) it made during the first access authorization request. Authorization upon request UR is a function that is implemented only for the services mentioned for a first communication terminal given in the customer account. These services will have been previously mentioned by the second communication terminal. The method for implementing the authorization upon request UR will be described below in conjunction with FIG. 5.

Service providing device 10 also comprises at least one installation code generator 24 capable of generating specific temporary codes for each customer account. These temporary codes comprise for example four digits. In the embodiment shown by way of example, each customer account comprises an installation code generator 24. Alternatively, the service providing device comprises a single generator capable of generating installation codes for all of the customer accounts.

Access control system 1 comprises a server 26 connected to network 12. Server 26 comprises an access control application 20 which can be distributed under the management of mobile terminals, also called an MDM application (for “Mobile Device Management”).

Access control application 20 is able to be downloaded onto first communication terminals or onto second communication terminals.

According to a variant not shown, access control application 20 to be downloaded is stored on service providing device 10.

FIG. 3 illustrates the steps of a method for the enrichment of the memory of device 10 and in particular of database 14, and of a method for the installation of access control for services on first communication terminal 6. It is assumed that at least one customer account 2 has already been created and that it already includes the following identification data: an identifier IDC2 of the second communication terminal, an authentication code AUTC2 of the second communication terminal, a identifier IDU6, IDU8 of the first communication terminals having a right to use the customer account, and an authentication code AUTU6, AUTU8 of the first communication terminals having a right to use the customer account.

FIG. 3 illustrates an example implementation of the method for the enrichment of database 14 in which the holder of customer account C2 subscribed to by the owner of second communication terminal 2 requests access control for the services provided to first communication terminal 6 and to first communication terminal 8.

The method for the enrichment of database 14 begins with a step 68 during which service providing device 10 receives a message containing identifier ID2-Account of the customer account, identifier IDU6, IDU8 of first communication terminals 6,8, and service identifications associated with first communication terminal 6 and first communication terminal 8. Only the services having the identifications contained in the message are authorized for viewing by the first communication terminal associated with them. The message includes, for example, service identifications C1, C2, and V, associated with first communication terminal 6, and service identifications C5, C7, and VG, associated with first communication terminal 8. Service identifications C1, C2, and V correspond to channel 1, channel 2, and video content. Service identifications C5, C7, and VG correspond to channel 5, channel 7, and video games. The message may also include an “authorization upon request” function UR linked to a service identification and to a first communication terminal identification. Step 68 of transmitting the identifier of the customer account, the identifier of the first communication terminal, the service identifications, and possibly the “authorization upon request” function UR, can be implemented:
either using the remote control of a television set directly connected to communications network 12 or connected to the network via an access unit (TV decoder or “set top box”),
or by entering data into customer account C2 by second communication terminal 2, a tablet, or a personal computer after entering the username and a password of the account holder. Transmission of authentication code AUTC2 of the second communication terminal can only be done from second communication terminal 2.

During a step 72, the service providing device saves service identifications C1, C2, V in database 14 such that they are linked to identifier “ID2-Account” of customer account C2 and to identifier IDU6 of the first communication terminal. In the same manner, service identifications C5, C7, and VG are saved in database 14 such that they are linked to identifier “ID2-Account” of customer account C2 and to identifier IDU8 of the first communication terminal. Lastly, when present, the “authorization upon request” function UR is saved together with identifier “ID2-Account” of the customer account, identifier IDU6 of the first communication terminal, and the associated service identification. In the example illustrated in FIG. 2, the “authorization upon request” function has been requested by second communication terminal 2 for video service V for first communication terminal 6 identified by identifier IDU6. The authorization upon request function UR has been requested by second communication terminal 2 for video game service VG for first communication terminal 8 identified by identifier IDU8.

In the present patent application, service identifications C1, C4, and V and the associated authorization upon request function UR constitute the “profile” of the first communication terminal identified by identifier IDU6. Service identifications C5, C7, and VG and the associated authorization upon request function UR constitute the “profile” of first communication terminal 8 identified by identifier IDU8.

During a step 74, generator 24 generates an installation code CD2.

During a step 76, the service providing device saves installation code CD2 in customer account C2 such that this code is linked or coupled to customer account identifier “ID2-Account”.

During a step 78, service providing device 10 transmits a text message to first communication terminal 6 and a text message to first communication terminal 8. These text messages include installation code CD2. To simplify FIG. 3, only first communication terminal 6 has been represented therein.

During a step 79, the first communication terminal 6 receives the text message transmitted by the service providing device.

During a step 80, the first communication terminal 6 downloads an access control application 20 from a server 26.

During a step 82, the user of first communication terminal 6 saves installation code CD2 received via text message in access control application 20.

During a step 84, the user of first communication terminal 6 captures biometric data such as a captured fingerprint. Authentication application 18 verifies that this biometric data is indeed identical to that of the holder of record of the first communication terminal. When this biometric data is identical to that of the holder of record of the first communication terminal, authentication application 18 generates an authentication code AUTU6. Alternatively, the user of first communication terminal 6 enters a personal identification number in authentication application 18 which generates an authentication code AUTU6 if this personal identification number is recognized.

During a step 85, first communication terminal 6 transmits a message to service providing device 10. This message comprises installation code CD2, authentication code AUTU6 generated during step 84, and identifier IDU6 of first communication terminal 6.

During a step 86, service providing device 10 receives the message comprising installation code CD2, authentication code AUTU6 of the first communication terminal, and identifier IDU6 of the first communication terminal.

During a step 88, the service providing device saves the received authentication code AUTU6 in database 14 such that it is linked to the identifier of the customer account and to identifier IDU6 of the first communication terminal. To create this link between the authentication code of the first communication terminal and the identifier of the customer account, the service providing device uses installation code CD2.

During a step 90, the service providing device transmits a text message to first communication terminal 6 to confirm the save in the database 14.

Steps 79 to 90 are also implemented with first communication terminal 8.

Alternatively, authentication code AUTU6 of the first communication terminal is generated only after authenticating biometric data of the owner of first communication terminal 6. Advantageously, this alternative is more secure because it allows ensuring that it is indeed the owner of the first communication terminal who is making the authentication request.

The method for the installation of access control for services on first communication terminal 6 comprises steps 79, 80, 82, 84 and 85 mentioned above.

When database 14 comprises the identification data of first communication terminals 6 and 8 and these first communication terminals include access control application 20, the method for controlling access to services can be implemented by service providing device 10.

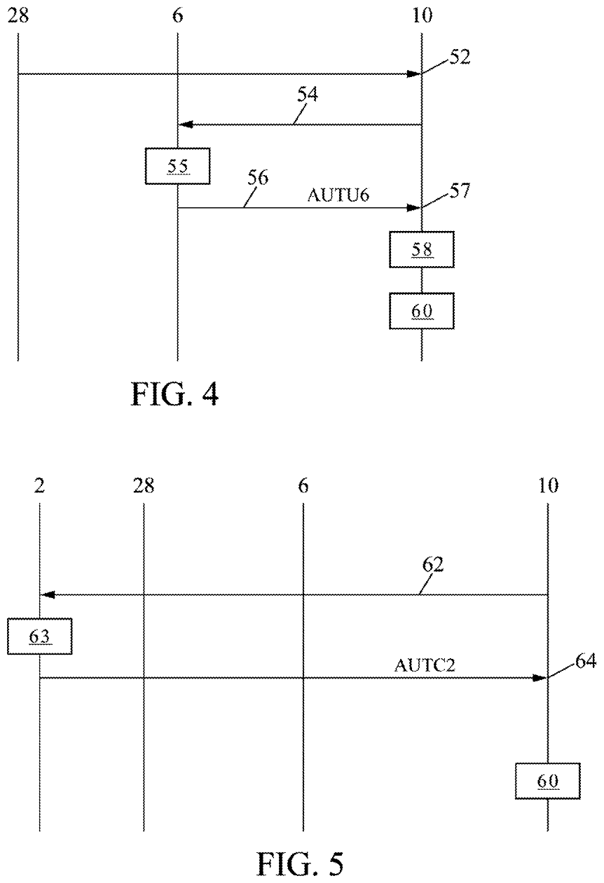

This method for controlling access to services will be described in conjunction with FIG. 4.

The method begins when a user connects to a customer account from a playback system 28. Playback system 28 is for example an assembly 32 comprising a television connected to a set top box. Profiles appear on the television screen. The user selects his or her profile using a remote control. During a step 52, service providing device 10 then receives a service request from playback system 28. The service request comprises identifier IDC2 of the customer account and identifier IDU6 of first communication terminal 6 linked to the profile selected by the user.

During a step 54, the service providing device transmits a text message confirmation to first communication terminal 6.

During a step 55, first communication terminal 6 receives the text message. Then, the user of first communication terminal 6 captures biometric data such as a captured fingerprint. Authentication application 18 verifies that this biometric data is indeed identical to that of the holder of record of the communication terminal. When this biometric data is identical to that of the holder of record of the communication terminal, authentication application 18 generates an authentication code AUTU6. Alternatively, the user of first communication terminal 6 enters a personal identification number in authentication application 18 which generates an authentication code AUTU6 if this personal identification number is recognized.

During a step 56, first communication terminal 6 transmits an authentication code AUTU6 to service providing device 10.

During a step 57, service providing device 10 receives authentication code AUTU6 coming from first communication terminal 6.

During a step 58, service providing device 10 compares received authentication code AUTU6 with authentication code AUTU6 saved in database 14 and linked to the identifier of first communication terminal 6.

If received authentication code AUTU6 is identical to authentication code AUTU6 stored in database 14 and linked to customer account identifier IDC2, service providing device 10 authorizes access, during a step 60, to the services identified in the profile of the first communication terminal.

The method for the confirmation, with a service providing device 10, of an access request for a viewing service comprises steps 55 and 56 mentioned above.

Referring to FIG. 5, when a service is linked to “authorization upon request” function UR, the method further comprises a step 62 during which the service providing device transmits an authorization upon request UR, via text message, to second communication terminal 2.

During a step 63, the owner of second communication terminal 2 enters a response (either acceptance or refusal) and captures biometric data or enters a PIN code. If this biometric data or this PIN code is recognized, authentication application 18 generates an authentication code AUTC2. Then, the first communication terminal transmits the response and authentication code AUTC2 of second communication terminal 2 to the service providing device.

During a step 64, the service providing device receives the response and authentication code AUTC2 of the second communication terminal.

Then, service providing device 10 makes use of the response during a step 60, if received authentication code AUTC2 is identical to authentication code AUTC2 of the second communication terminal stored in the customer account.

Advantageously, a user can have his or her communication terminal identifier registered with several customer account holders as represented in FIG. 2. The user of the communication terminal identified by identifier IDU6 is registered with the same service provider. These television profiles are different from one customer account to another. These accesses to the services provided by the service providing device are managed by the same access control application 20.

Advantageously, the first communication terminal of a home childcare provider could only have access to channels for children, selected by the parent who is the holder of the customer account. The home childcare provider thus would not be able to watch programs that are inappropriate for the child.

When the identifier of the first communication terminal is registered with two different service providers, the first communication terminal must download two different access control applications onto its first communication terminal, each specific to a service provider.

An exemplary embodiment of the present application aims to allow personalization of televised services while allowing verification of the owner of the customer account obligated to pay the access provider for the consumption of services such as videos, pay television, video games, etc.

Although the present disclosure has been described with reference to one or more examples, workers skilled in the art will recognize that changes may be made in form and detail without departing from the scope of the disclosure and/or the appended claims.

1. A method for controlling access to services, the services being provided by a service providing device and intended for a playback system, wherein the method is implemented by the service providing device and comprises:
transmitting a confirmation request to a first communication terminal associated with a customer account in the service providing device, after receiving an access request for at least one service, the access request coming from the playback system and comprising an identifier of said customer account, and
then, accessing said at least one service in response to an authentication code received from said first communication terminal is being identical to an authentication code associated with the customer account.

2. The method for controlling access according to claim 1, wherein the received access request for said at least one service was sent by one of the following devices:
the first communication terminal,
a playback system comprising a communication unit for communicating with the communications network and a display screen.

3. The method for controlling access according to claim 1, wherein the customer account comprises at least one service identification linked to the identifier of the first communication terminal and to the identifier of the customer account, said access being given to the identified communication terminal only for at least the service having a service identification mentioned in the customer account and linked to the identifier of the first communication terminal.

4. The method for controlling access according to claim 1, wherein the customer account comprises an identifier of a second communication terminal having subscribed to the customer account and an authentication code of said second communication terminal, and wherein the customer account comprises an authorization upon request, the method further comprising:
transmitting an authorization request to the second communication terminal,
receiving a response and an authentication code from the second communication terminal, said response being a right of access to the service among the following:
authorization to access the service,
refusal of access to the service,
implementing the response if the received authentication code is identical to the authentication code of the second communication terminal stored in the customer account.

5. A service providing device providing services intended for a playback system, the service providing device comprising:
a transmitter;
a processor; and
a non-transitory computer readable medium comprising instructions stored thereon which when executed by the processor configure the service providing device to:
send, using the transmitter, a confirmation request to a first communication terminal associated with a customer account in the service providing device, after receiving an access request for at least one service, the access request coming from the playback system and comprising an identifier of said customer account, and
provide said at least one service in response to an authentication code received from said first communication terminal being identical to an authentication code associated with the customer account.

6. A confirmation method for confirming with a service providing device an access request for at least one service, wherein the method comprises is implemented by a first communication terminal and comprises:
receiving a confirmation request coming from the service providing device, and
transmitting an authentication code to the service providing device, said authentication code being generated by an authentication application after an authentication among the following:
authentication of biometric data of the owner of the first communication terminal,
authentication of a personal identification number entered on the first communication terminal.

7. The confirmation method according to claim 6, wherein said authentication code of the first communication terminal is generated only after authentication of biometric data of an owner of the first communication terminal.

8. A communication terminal comprising:
a transmitter;
a receiver;
a processor; and
a non-transitory computer readable medium comprising instructions stored thereon which when executed by the processor configure the communication terminal to:
receive with the receiver a confirmation request;
generate an authentication code by an authentication application after performing an authentication among the following:
authentication of biometric data of an owner of the communication terminal,
authentication of a personal identification number entered on the communication terminal; and
transmit with the transmitter the authentication code.

9. An enrichment method for enrichment of a memory of a service providing device for controlling access to services, said service providing device being connected to a communications network, said service providing device comprising a generator suitable for generating an installation code, wherein the method is implemented by the service providing device and comprises:
generating an installation code and saving said installation code while associating the installation code with an identifier of a customer account,
transmitting said installation code to a first communication terminal,
receiving a message from the first communication terminal, said message including an authentication code of the first communication terminal, the identifier of the first communication terminal, and said installation code, and
saving the received authentication code in the memory of the device such that said authentication code is associated with the identifier of the customer account and with the identifier of the first communication terminal by using the installation code.

10. The enrichment method according to claim 9, further comprising:
receiving the identifier of the customer account, the identifier of the first communication terminal, and at least one service identification, only the service having said identification being authorized for viewing by said first communication terminal,
saving said at least one service identification in the memory of the service providing device, said at least one service identification being linked to the identifier of the first communication terminal and to the identifier of the customer account.

11. The enrichment method according to claim 9, further comprising transmitting a text message to the first communication terminal to confirm the saving of said at least one service identification in the memory of the service providing device.

12. An installation method for installation, on a first communication terminal connected to a communications network, of access control for services, wherein the method is implemented by the first communication terminal and comprises:
receiving an installation code coming from a service providing device,
downloading an access control application to the first communication terminal,
generating an authentication code, by the authentication application, after performing an authentication among the following:
authentication of biometric data of an owner of the first communication terminal,
authentication of a personal identification number entered on the first communication terminal,
transmitting the installation code, the generated authentication code, and an identifier of the first communication terminal, to the service providing device.

13. The installation method according to claim 12, wherein said authentication code of the first communication terminal is generated only after authentication of biometric data of the owner of the first communication terminal.
